(19) United States
(12) Patent Application Publication
(10) Pub. No.: US 2004/0214048 A1
(43) Pub. Date: Oct. 28, 2004

(54) Magnetic recording medium

(75) Inventors: Tsutomu Ide, Tokyo (JP); Katsuhiko Yamazaki, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: TDK CORPORATION, Tokyo (JP)

(21) Appl. No.: 10/829,283

(22) Filed: Apr. 22, 2004

(30) Foreign Application Priority Data
Apr. 22, 2003 (JP) 2003-117216

(51) Int. Cl. B32B 5/16

(52) U.S. Cl. 428/694 TR; 428/694 B

(57) ABSTRACT

The present invention provides a magnetic recording medium having high durability and reliability compatible with MR heads by satisfactorily controlling the grinding ability irrespective of materials, dispersion methods, application methods and other manufacturing methods.

The invention provides a recording medium at least having a nonmagnetic layer and magnetic layer sequentially laminated on one surface of a nonmagnetic substrate. The magnetic layer contains a magnetic powder, a binder resin and an abrasive, and an average height of protrusion of the abrasive from the surface of the magnetic layer measured using an AFM is in the range of 7.0 to 15.0 nm.

### BACKGROUND OF THE INVENTION

1. Field of the Invention

The present invention relates to a magnetic recording medium, particularly to a laminated magnetic recording medium having an appropriate grinding ability compatible with a magnetoresistive (MR) head. 2. Description of the Related Art

The grinding ability of a magnetic recording medium is one of the crucial factors for maintaining durability and reliability of the medium. Accordingly, various investigations have been made with respect to the relationship between an abrasive added to a magnetic layer and the grinding ability.

A grinding test using a sendust bar is well known as a criterion for evaluating the grinding ability of magnetic recording media (described in Japanese Unexamined Patent Application Publication No. 11-283237. Japanese Unexamined Patent Application Publication No. 11-283237 describes a technique in which the magnetic layer is controlled to a given thickness or less to obtain a magnetic recording medium suitable for high density recording and having excellent durability and productivity, while hardness of the abrasive added to the magnetic layer and the average protrusion height of the abrasive from the surface of the magnetic layer, and average surface roughness of the magnetic layer are controlled within prescribed ranges. Japanese Unexamined Patent Application Publication No. 2002-312920 describes a technique for controlling the proportion of the number of protrusions of the abrasive having a height of a prescribed level or less within a given range by observing the protrusions of the abrasive on the surface of the magnetic layer using an atomic force microscope (AFM). A high output magnetic recording medium capable of high density recording while having excellent running durability can be manufactured based on the observation above.

However, it has not been clearly elucidated how the grinding ability as an important factor should be controlled, or how the surface state of a tape should be determined to obtain good grinding ability.

Since a system employing an MR head has been developed in recent years for complying with high density recording, control of the grinding ability of the tape has became more important. While it is required for complying with high density recording to design a magnetic recording medium considering the planarity of the surface of the tape and the fineness of pulverized magnetic powders, and to reduce the particle diameter of a magnetic paint-dispersing media accordingly, a large problem in the magnetic recording medium is controlling the grinding ability that is contradictory to the planarity of the surface and fineness of the magnetic powder.

### SUMMARY OF THE INVENTION

Accordingly, it is an object of the present invention grinding ability even by employing any materials and dispersion methods in any coating methods and other manufacturing methods, and to provide a magnetic recording medium having excellent durability and reliability capable of complying with any MR heads.

The inventors of the present invention found, through intensive studies for solving the problems above, that the grinding ability can be satisfactorily controlled irrespective of the materials and manufacturing methods of the magnetic recording medium by controlling the height of protrusion of the abrasive on the surface of the magnetic recording medium measured with an AFM within a prescribed range. The inventors found that a magnetic recording medium being excellent in both high durability and high reliability could be obtained by the method above, and have completed the present invention.

The present invention provides a magnetic recording medium at least having a nonmagnetic layer and a magnetic layer sequentially laminated on one surface of a nonmagnetic substrate. The magnetic layer contains a magnetic powder, a binder resin and an abrasive, and an average height of protrusion of the abrasive from the surface of the magnetic layer measured using an AFM is in the range of 7.0 to 15.0 nm.

The present invention is particularly effective in a magnetic recording system comprising an MR head as a reproduction head. In the MR head, the track width is preferably 1-12 μm, more preferably 1-6 μm, the tape speed is preferably 2-20 m/min, more preferably 8-12 m/min and the tape tension is preferably 0.4-2.0 N/10 mm. These preferable ranges are preferably applicable to the average height of protrusion of the abrasive. Further, the magnetic layer is preferably formed by a wet-on-dry method. The magnetic layer preferably has a surface roughness Ra of 5 nm or less measured with the AFM.

The art described in the Japanese Unexamined Patent Application No. 11-283237 is related to a monolayer recording medium, and has a different technical spirit from that of the present invention. The technical spirit of the art described in the Japanese Unexamined Patent Application No. 2002-312920 is also different from that in the present invention in which the magnetic recording medium is compatible with an MR head that has high sensitivity as a reproduction head but is readily damaged by sliding movement on the magnetic medium.

### BRIEF DESCRIPTION OF THE DRAWINGS

FIG. 1 is a graph showing the relationship between the average height of protrusion of the abrasive and the amount of wear in examples;

FIG. 2A shows a cross-section of a measuring apparatus for measuring the amount of wear of sendust;

FIG. 2B describes the method for evaluating the amount of wear of sendust; and

FIG. 3 is a graph describing the method for defining the reference plane of the magnetic layer, wherein the horizontal axis shows the height of protrusion from the surface of the nonmagnetic substrate, and the vertical axis shows the occupation ratio of the magnetic layer in a plane at each elevation from the nonmagnetic substrate.

### DESCRIPTION OF THE PREFERRED EMBODIMENTS

The embodiment of the invention will be described in detail hereinafter.

The magnetic recording medium of the invention medium comprises at least a nonmagnetic layer and a magnetic layer sequentially laminated on one surface of a nonmagnetic substrate, and the height of protrusion of an abrasive contained in the magnetic layer satisfies the conditions prescribed below.

An average height of protrusion of the abrasive from the surface of the magnetic layer measured by using an AFM is in the range of 7.0 to 15.0 nm, preferably 8.5 to 14.0 nm, in the magnetic recording medium of the present invention. The durability of the magnetic recording medium may be deteriorated due to small grinding ability of the magnetic recording medium when the average height of protrusion is less than 7.0 nm, while the MR head may be damaged resulting in damage of the durability due to too large grinding ability of the magnetic recording medium when the average height of protrusion is larger than 15.0 nm. The invention provides the magnetic recording medium being compatible with a magnetic recording system comprising the readily damaged MR head as a reproduction head, by prescribing the average height of protrusion of the abrasive within the range described above.

Since the magnetic layer contains at least the magnetic powder, binder resin and abrasive, the magnetic powder or abrasive is considered to protrude out of the surface of the magnetic layer. An AFM image and a SEM (scanning electron microscope) image are compared to one another using the AFM and SEM together to locate the magnetic powder and abrasive on the surface of the magnetic layer.

Since fine roughness is formed on the surface of the magnetic layer due to protrusion of the magnetic powder or abrasive, the surface state of the magnetic layer as a criterion of the height of protrusion of the abrasive cannot be simply determined. The surface state of the magnetic layer as the criterion is defined as follows in the present invention.

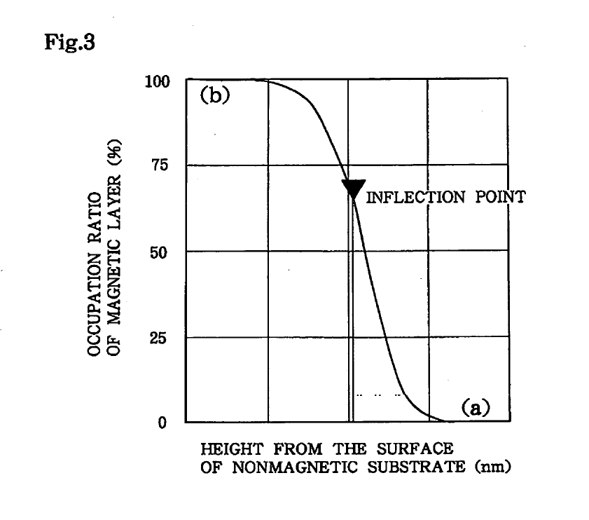

The height of a plane, which is parallel to the surface of a nonmagnetic substrate and is located above the magnetic layer having a finely roughened surface, from the surface of the nonmagnetic substrate is used as a horizontal axis, and an area ratio (p/q) between a sum (p) of cross-sectional areas of the ridges of the roughened surface cut by the plane and an area (q) of the plane is used as a vertical axis. The plane parallel to the surface of the nonmagnetic substrate at an elevation where a curve representing the area ratio at the height of the parallel plane exhibits an inflection point is used as a reference plane. In practice, the area ratio (p/q) is plotted against the height of the plane from the surface of the nonmagnetic substrate to draw a curve representing the variation ratio of the proportion of the magnetic layer occupying the horizontal plane at each height, and a height where the curve exhibits an inflection point is defined as the reference plane of the magnetic layer. This procedure may be achieved using the AMF, and a curve between the height vs. magnetic layer occupation ratio as shown in FIG. 3 is obtained. As shown in the graph, the occupation ratio (Y) of the magnetic layer is 100% at the minimum height (b), while the ratio (Y) is 0% at the maximum height. The height at the reference plane corresponds to the height at the inflection point shown in the direction of the arrow in the graph, or the horizontal plane corresponding to the X-coordinate at the inflection point is the standard plane of the magnetic layer. Accordingly, the height of protrusion from the surface of the magnetic layer is measured with AFM using the horizontal plane defined above as a reference plane, and the average height of protrusion is obtained by calculating an average of the height of protrusion.

In fact, the height of protrusion is obtained as a distance from the elevation of the surface of the magnetic layer at a selected cross-sectional plane to the maximum height of the abrasive, by determining the cross-sectional shape of the surface of the magnetic layer using AFM at a maximum height of a selected abrasive after locating the abrasive using AFM and SEM together. The data according to the procedure above can be processed using, for example, SPMLab NT Ver. 501b11(date-processing application) available from Thermo Microscope Co.

For properly controlling grinding ability by providing an average height of the abrasive of the present invention, the paint for forming the magnetic layer is dispersed under a given condition in the process for manufacturing the magnetic recording medium, and the height of protrusion of the abrasive is controlled by grinding using an abrasive tape or blade after forming the magnetic recording medium. A desired height of protrusion may be obtained by appropriately using these methods to enable the grinding ability to be favorably controlled.

For controlling the dispersion condition of the paint, the rotational circumference speed of a dispersion machine for dispersing the paint, the material of the dispersion medium, and the diameter of dispersed particles are appropriately determined for controlling the degree of dispersion contained in the paint. Consequently, the height of protrusion of the abrasive on the surface of the magnetic recording medium can be properly controlled by controlling the dispersion state of the abrasive in the paint. In practice, the circumference speed of the dispersion machine is increased, the density of beads is increased, and the diameter of the beads is reduced when the height of protrusion of the abrasive is to be reduced. For example, a pin-mill is used as the dispersion machine at a circumference speed of 5 to 15 m/s, and zirconia beads with a particle diameter of 0.05 to 0.8 mm may be used as the dispersion medium.

For controlling the surface roughness by grinding the surface of the magnetic layer using an abrasive tape, the abrasive tape running in a given direction is pressed onto the surface of the magnetic recording medium for grinding the medium while the magnetic recording medium is wound onto a reel hub after cutting a roll of the magnetic recording medium (cut-lapping). The height of protrusion of the abrasive on the surface of the magnetic recording medium may be appropriately adjusted by appropriately changing the material or the depression distance of the abrasive tape. For example a harder material is used for the abrasive tape and the depression distance is increased for reducing the height of protrusion of the abrasive. The height of protrusion tends to be relatively uniformly reduced for the abrasive having larger to smaller heights of protrusion, when the abrasive tape is used for grinding the surface. An abrasive tape having a material comprising 5,000 to 10,000 mesh alumina as abrasive particles may be used for grinding. The depression distance in this case is, for example, 5 to 40 mm.

For controlling the height of protrusion of the abrasive by grinding the surface of the magnetic layer using a blade(blade grinding), the blade is pressed onto the surface of the running magnetic recording medium when the magnetic recording medium wound around a reel hub is made to run along a guide roll and wound up again on a different reel hub for grinding the surface of the magnetic recording medium. The height of protrusion of the abrasive on the surface of the magnetic recording medium may be appropriately adjusted by changing the extent of displacement of the blade onto the surface of the magnetic recording medium. For example, the blade is largely displaced onto the surface of the magnetic recording medium when the height of protrusion of the abrasive is to be more reduced. A triangular column of sapphire may be used, for example, as the blade. The surface of the magnetic recording medium may be ground by displacing the longitudinal edge of the triangular column about 0.5 to 3 mm perpendicular to the surface of the magnetic recording medium. The abrasive particles having a larger height of protrusion tend to be preferentially ground by surface grinding using the blade.

While two methods of cut-lapping and blade grinding are available for controlling the grinding ability of the magnetic recording medium by grinding the surface of the magnetic layer, one of these methods may be used alone, or the methods may be used in combination. It is an advantage of using the method that the magnetic tape can be ground simultaneously while cutting it by using an abrasive tape having the same width as that of an original roll of the magnetic recording medium. Naturally, the method may be used for grinding respective magnetic tapes after cutting. Since a triangular sapphire blade with a length of about 3 cm is usually used for the blade grinding method, this method is favorably used for grinding the magnetic tape after cutting. The method for controlling the dispersion condition of the paint may be naturally used in combination with other methods.

The average surface roughness Ra of the magnetic layer measured with AFM is 5 nm or less, preferably 1.5 to 4.5 nm in the present invention. The effect of the present invention may be more favorably exhibited by controlling the average surface roughness to be 5 nm or less. The running state tends to be unstable due to an increase of friction when the average surface roughness is less than 1.5 nm, while output of the magnetic recording medium decreases by spacing lose to increase the incidence of errors when the average surface roughness exceeds 4.5 nm.

Specific conditions for forming the magnetic layer and nonmagnetic substrate such as the materials, constructions and coating methods thereof are not particularly restricted so long as the average height of protrusion of the abrasive satisfies the range described above in the magnetic recording medium of the present invention. An example of the construction is as follows.

The magnetic powder used in the magnetic layer is a needle-like ferromagnetic metal powder having an average major axis length of preferably 0.15 μm or less, more preferably 0.03 to 0.10 μm. Electromagnetic conversion characteristics (particularly S/N and C/N characteristics) cannot be sufficiently achieved when the average major axis length exceeds 0.15 μm. A hexagonal iron oxide powder such as barium ferrite may also be used. The aspect ratio of the iron oxide powder of hexagonal crystal system is preferably 2 to 7. The average disc diameter of the powder particles determined by TEM observation Is preferably 10 to 50 nm, since the surface of the magnetic layer tends to be roughened when the diameter is large.

The magnetic layer may contain such a magnetic powder in a proportion of 65 to 90% by mass. Surface smoothness after calender treatment is deteriorated when the content of the magnetic powder is too large, while a high regeneration output cannot be obtained when the content is too small.

The binder resins favorably available for the magnetic layer include a thermoplastic resin, thermosetting resin and radiation curing resin, and mixtures thereof without any restriction. These binder resins are added in a proportion of preferably 5 to 40 parts by mass, particularly 10 to 30 parts by mass, relative to 100 parts by mass of the magnetic powder. Running durability is deteriorated when the content of the binder resin is too small, since the strength of the magnetic layer decreases. The electromagnetic conversion characteristics are decreased, on the other hand, when the content of the binder resin is too large, since the content of the ferromagnetic metal powder decreases.

Examples of cross-linking agents for curing these binder resins include known various polyisocyanates, and the content of this cross-linking agent is preferably 10 to 30 parts by mass relative to 100 parts by mass of the binder resin. While the magnetic powder, binder resin and abrasive are added to the magnetic layer, other additives including a dispersant such as a surfactant and higher fatty acids may be added, if necessary.

Examples of the abrasive favorably used for the magnetic layer preferably include the abrasives having a Moh's hardness of 6 or more such as α-alumina (Moh's hardness 9), chromium oxide (Moh's hardness 9), silicon carbide (Moh's hardness 9.5), silicon oxide (Moh's hardness 7), aluminum nitride (Moh's hardness 9) and boron nitride (Moh's hardness 9.5). It is favorable to add at least one abrasive having a Moh's hardness of 9 or more in the magnetic layer. Fluctuation of output may be reduced and running durability may be improved when at least two abrasives having different average particle diameters to each other are used.

The average particle diameter of the abrasive is preferably smaller than the thickness of the magnetic layer, and is usually 0.01 to 0.2 μm, preferably 0.05 to 0.2 μm. The protrusion height of the particles from the surface of the magnetic layer becomes too large when the average particle diameter is too large causing a decrease of the electromagnetic conversion characteristics and an increase of drop-out, and an increase of the degree of wear of the head. When the average particle diameter of the abrasive is too small, on the other hand, the amount of protrusion of the abrasive from the surface of the magnetic layer becomes so small that plugging of the head cannot be sufficiently prevented. The average particle diameter is usually measured with a TEM. The content of the abrasive is usually 3 to 25 parts by mass, preferably 5 to 20 parts by mass, relative to 100 parts by mass of the magnetic powder. For example, alumina with an average particle diameter of 0.2 μm or less is added in a proportion of 5 to 20 parts by mass relative to 100 parts by mass of the magnetic powder. The content of the abrasive in the range as described above facilitates the height of the abrasive to be controlled by a treatment such as surface grinding.

The paint for forming the magnetic layer is prepared by adding an organic solvent to the components described above. The organic solvents available are not particularly restricted, and one or at least two ketone solvents such as methylethyl ketone (MEK), methylisobutyl ketone and cyclohexanone and aromatic solvents such as toluene may be appropriately selected for use. The amount of addition of the organic solvent is about 100 to 1100 parts by mass relative to 100 parts by mass of a combined amount of the solvent and binder resin.

The thickness of the magnetic layer in the present invention is usually 0.50 μm or less, preferably 0.01 to 0.50 μm, and more preferably 0.02 to 0.30 μm. Self demagnetization loss and thickness loss are increased when the magnetic layer is too thick, while the strength of the coating layer decreases when the layer is too thin.

While the magnetic layer is formed by laminating it on the nonmagnetic layer at one side of the nonmagnetic substrate, a wet-on-dry (W/D) method is favorably used, whereby the magnetic layer as an upper layer is coated on the nonmagnetic layer as an underlayer after uniformly coating and drying the nonmagnetic layer. When the magnetic layer is coated by a wet-on-wet method, the particle diameter of the abrasive used in the magnetic layer is required to be large since the solid fraction in the magnetic layer tends to be embedded in the coating layer during application causing the MR head to be readily damaged. On the other hand, since the abrasive having a small particle diameter may be used in the W/D method, impact applied on the MR head may be reduced. In addition, since uniformity of the thickness of the magnetic layer is enhanced, the abrasive is evenly protruded from the magnetic layer, and the grinding ability and scratch resistance may be satisfactorily prevented from being irregular.

The nonmagnetic substrate may be appropriately selected from known resin films such as polyester, polyamide and aromatic polyamide films, and laminated films of these resins. The thickness may be within the range known in the art, and is not particularly restricted.

The nonmagnetic layer mainly comprises the nonmagnetic powder and binder resin, and is provided on the nonmagnetic substrate. While various inorganic powders may be used as the nonmagnetic powder, they are preferably needle-like nonmagnetic powders such as needle-like nonmagnetic iron oxide (α-Fe₂O₃). Other nonmagnetic powders such as calcium carbonate (CaCO₃), titanium oxide (TiO₂), barium sulfate (BaSO₄) and α-alumina (α-Al₂O₃) may be appropriately blended. Carbon black is also preferably used for the nonmagnetic layer. Examples of carbon black available include furnace black for rubbers, thermal black for rubbers, color black and acetylene black.

The proportion of blending of carbon black to the inorganic powder is preferably 100/0 to 10/90 in the mass ratio. Surface electric resistance becomes unsatisfactory when the blend ratio of the inorganic powder exceeds 90.

Known thermoplastic resins, thermosetting resins and radiation curing resins, and mixtures thereof, may be appropriately used as the binder resin for the nonmagnetic layer as In the magnetic layer, and the resins are not particularly restricted. When an EB (electron beam) curing resin is used as the binder resin, the dosage of EB for curing the coating layer formed is preferably suppressed in the range of 3.5 to 6.0 Mrad, since stiffness of the magnetic tape is suppressed to permit the tape to gently contact the MR head enabling the wear-preventive effect of the MR head to be improved.

A dispersant such as a surfactant and other additives may be added to the nonmagnetic layer, if necessary. The paint for the nonmagnetic layer can be formed by adding the same organic solvent in the same amount as forming the nonmagnetic layer.

The thickness of the nonmagnetic layer is preferably 2.5 μm or less, more preferably 0.1 to 2.3 μm. Improvements of performance cannot be expected by increasing the thickness to larger than 2.5 μm. The thickness of the coating layer becomes rather uneven with a severe coating condition, and the surface smoothness tends to be poor. When the thickness is smaller than 0.1 μm, on the other hand, it is difficult to even the roughness of the nonmagnetic substrate, and the amount of a lubricant supplied to the magnetic layer is decreased deteriorating the durability of the magnetic tape.

The back-coat layer is provided, if necessary, on the surface opposite to the surface of the nonmagnetic substrate on which the nonmagnetic layer and magnetic layer are formed for improving the running stability and for preventing charging of the magnetic layer. The back-coat layer preferably contains 30 to 80% by mass of carbon black, which may be any carbon black usually used, and may be the same as that used in the nonmagnetic layer. Nonmagnetic Inorganic powders such as various abrasives, dispersants such as surfactants, lubricants such as higher fatty acids, fatty acid esters and silicone oils used in the magnetic layer, and other additives may be added, if necessary, to the back-coat layer.

The thickness (after calendering) of the back-coat layer is 0.1 to 1.0 μm, preferably 0.2 to 0.8 μm. Running stability tends to decrease due to too large a friction between the back-coat layer and a slide-contact passageway of the medium when the thickness exceeds 1.0 μm. On the other hand, the back-coat layer is readily peeled off during running of the magnetic recording medium when the thickness is less than 0.1 μm.

According to the present invention described above, grinding ability may be satisfactorily controlled irrespective of materials, dispersion methods, application methods and other manufacturing methods. Accordingly, the present invention provides a magnetic recording medium having high durability and reliability compatible with MR heads.

### EXAMPLES

The present invention will be described in detail with reference to drawings.

### Example 1

The paints for the nonmagnetic layer, magnetic layer and back-coat layer were prepared as follows. “Parts” for expressing the compositions refer to “parts by mass” hereinafter.

<Composition of Nonmagnetic Layer>

| | |
|---|---|
| Needle-like α-FeOOH | 80.0 parts |
| (average major axis length: 0.1 μm, crystal grain | |
| diameter: 12 nm) | |
| Carbon black | 20.0 parts |
| (trade name #950B manufactured by Mitsubishi Chemical | |
| Co., average particle diameter: 17 nm, BET specific | |
| surface area: 250 m²/g, DBP oil absorption ratio: 70 ml/100 g, | |
| pH: 8) | |
| Vinyl chloride resin | 11.0 parts |
| (trade name TB-0246 manufactured by Toyobo Co., (solid | |
| fraction) copolymer of vinyl chloride-epoxy containing | |
| monomer, average degree of polymerization: 310, S | |
| content by a potassium persulfate method: 0.6% by mass, | |
| acrylate-modified MR110 using 2-isocyanate ethyl | |
| methacrylate (MOI) manufactured by Nippon Zeon Co., | |
| acryl content: 6 mole/1 mole) | |
| Polyurethane resin | 9.0 parts |
| (trade name TB-0216 manufactured by Toyobo Co., (solid | |
| fraction) hydroxyl-containing acrylic compound-sulfonic | |
| acid-containing phosphorus compound-hydroxyl-containing | |
| polyester polyol, average molecular weight; 13,000, P- | |
| content: 0.2% by mass, acryl content: 8 mole/1 mole) | |
| Dispersant | 1.2 parts |
| (trade name Re610 manufactured by Toho Chemical | |
| Industry Co.) | |
| phenylsulfonic acid | 2.0 parts |
| Abrasive | 5.0 parts |
| (trade name HIT60A manufactured by Sumitomo Chemical | |
| Co., α-alumina, average particle diameter: 0.22 μm) | |

MEK/toluene/cyclohexane = 2/2/1 (mass ratio)

After kneading the materials above using a kneader, the mixture was dispersed at a dispersion circumference speed of 7.0 m/s using a horizontal pin-mill filled with zirconia beads with a particle diameter of 0.8 mm at a packing ratio of 80% (void ratio 50% by volume) to obtain a mixed solution with a solid fraction concentration (NV) of 33% by mass.

The following lubricants and solvents were added to the mixed solution, and the mixture was further dispersed so that NV becomes 25% by mass.

| Lubricant | |
|---|---|
| (fatty acid, trade name NAA180 manufactured by Nippon | 0.5 parts |
| Oils and Fats Co.) | |
| (fatty acid amide, trade name Fatty Acid Amide S | 0.5 parts |
| manufactured by Kao Co.) | |
| (fatty acid ester, trade name NIKKOLBS manufactured by | 1.0 part |
| Nikko Chemicals Co.) | |

MEK/toluene/cyclohexane = 1/1/3 (mass ratio)

The mixture was filtered with a filter with an average pore size of 0.5 μm to obtain the paint for the nonmagnetic layer.

<Composition of Nonmagnetic layer>

| | |
|---|---|
| Needle-like Fe magnetic powder | 100 parts |
| (Fe/Co/Al/Y = 100/24/5/8 (atomic ratio), Hc: 194 kA/m, | |
| σₛ: 140 Am²/kg, BET specific surface area: 56 m²/g, | |
| average major axis length = 0.075 μm) | |
| Vinyl chloride resin | 14.0 parts |
| (trade name MR110 manufactured by Nippon Zeon Co., vinyl | |
| chloride copolymer) | |
| Polyurethane | 2.0 parts |
| (trade name UR8700 manufactured by Toyobo Co., polyester | |
| polyurethane) | |
| Dispersant | 3.0 parts |
| (trade name RE610 manufactured by Toho Chemical Co.) | |
| Abrasive | |
| (α-alumina, trade name HIT82 manufactured by Sumitomo | 7.0 parts |
| Chemical Industry Co., average particle diameter: 0.12 μm) | |
| (α-alumina, trade name HIT60A manufactured by Sumitomo | 3.0 parts |
| Chemical Industry Co., average particle diameter: 0.18 μm) | |
| Lubricant | |
| (fatty acid, trade name NAA180 manufactured by Nippon | 1.2 parts |
| Fats and Oils Co.) | |
| (fatty acid ester, trade name NIKKOLBS manufactured by | 1.0 part |
| Nikko Chemicals Co.) | |

MEK/toluene/cyclohexanone = 1/1/1 (mass ratio)

After kneading the materials above using a kneader, the mixture was dispersed at a circumference rate of 5.4 m/s using a pin-mill filled with zirconia beads with a particle diameter of 0.8 mm at a packing ratio of 804 (void ratio 50% by volume), and a mixed solution with a solid fraction concentration (NV) of 30% by mass was obtained.

The mixed solution was further dispersed by adding the following solvent to An NY value of 16% by mass. MEK/toluene/cyclohexane=1/1/3 (mass ratio)

The following curing agent was mixed with the mixed solution above, and the solution was filtered using a filter with an average pore size of 0.5 μm to prepare a paint for the magnetic layer.

| | |
|---|---|
| Curing agent | 10 parts |
| (trade name Collonate L manufactured by Nippon | |
| Polyurethane Co.) | |

<Composition of Back-coat Layer>

| Carbon black | |
|---|---|
| (trade name BP-800 manufactured by Cabot Co., average | 75 parts |
| particle diameter: 17 nm, DBP oil absorbing ratio: 68 cc/100 g, | |
| BET surface area: 210 m²/g) | |
| (trade name BP-130 manufactured by Cabot Co., average | 10 parts |
| particle diameter: 75 nm, DBP oil absorbing ratio: 69 cc/100 g, | |
| BET surface area: 25 m²/g) | |
| Calcium Carbonate | 15 parts |
| (trade name Hakuen-ka manufactured by Shiraishi K.K., | |
| average particle diameter: 30 nm) | |
| Nitrocellulose | 65 parts |
| (trade name BTH 1/2 manufactured by Asahi Chemical | |
| Industry Co.) | |
| Polyurethane resin | 35 parts |
| (aliphatic polyester diol/aromatic polyester diol = 43/53) | |

MEK/toluene/cyclohexanone = 1/1/1 (mass ratio)

After kneading the materials above using a kneader, the mixture was dispersed at a circumference rate of 5.4 m/s using a pin-mill filled with zirconia beads with a particle diameter of 0.8 mm at a packing ratio of 80% (void ratio 50% by volume), and a mixed solution with a solid fraction concentration (NV) of 30% by mass.

The mixed solution was further dispersed by adding the following solvent to an NY value of 12% by mass. MEK/toluene/cyclohexane=5/4/1 (mass ratio)

The following curing agent was added to the mixed solution above with mixing, and the solution was filtered with a filter with an average pore diameter of 0.5 μm to prepare the paint for the back-coat layer.

| | |
|---|---|
| Curing agent | 5 parts |
| (trade name Collonate L manufactured by Nippon | |
| Polyurethane Co.) | |

Samples of the magnetic recording medium was prepared as follows using the paints for the nonmagnetic layer, magnetic layer and back-coat layer obtained as described above.

<Coating Step>

The paint for the nonmagnetic layer was sprayed, followed by drying, through a nozzle on one surface of the polyethylene terephthalate (PET) substrate with a thickness of 6.2 μm so that the thickness after calender treatment is 2.0 μm. The layer was subjected to calender processing using a combination of a plastic roll and metal roll under a condition of a nip number of 4, a processing temperature of 100° C., a linear pressure of 3500 N/cm and a calendar rate of 150 m/min. The nonmagnetic layer was formed by irradiating an electron beam at a dosage of 4.5 Mrad thereafter.

The paint for the magnetic layer was sprayed, followed by drying and orientation, through a nozzle on the nonmagnetic layer formed as described above so that the thickness after calender treatment is 0.15 μm. The layer was subjected to calender processing using a combination of a plastic roll and metal roll under a condition of a nip number of 6, a processing temperature of 100° C., a linear pressure 3500 N/cm and a calendar rate 150 m/min to form the magnetic layer.

Subsequently, the paint for the back-coat layer was sprayed, followed by drying, through a nozzle on one surface of the polyethylene terephthalate (PET) substrate opposed to the nonmagnetic layer and magnetic layer so that the thickness after calender treatment is 0.7 μm. The layer was subjected to calender processing using a combination of a plastic roll and metal roll under a condition of a nip number of 4, a processing temperature of 80° C., a linear pressure 3500 N/cm and calendar rate 150 m/min to form the back-coat layer.

The web of the magnetic recording medium prepared as described above was cured by heating at 60° C. for 48 hours.

The web of the magnetic recording medium after curing was cut into a half width, and the magnetic tape in Example 1 was obtained by grinding the surface of the magnetic layer of the magnetic recording medium with a blade (blade grinding) after cutting. The blade grinding condition is as follows (the conditions were the same in the examples and comparative examples except Example 2).

<Blade Grinding Condition>

The magnetic recording medium wound around a reel hub was allowed to run along a guide roll, and was wound again on another reel hub. The surface of the magnetic recording medium was ground by displacing the blade (material: sapphire, shape: triangular column) onto the surface of the running magnetic recording medium with a displacement (amount of protrusion) of 1 mm while the magnetic recording medium was re-wound on the reel hub.

### Example 2

A magnetic tape sample in Example 2 was obtained by the same method as in Example 1, except that displacement of the blade was changed to 0.5 mm in the blade grinding condition.

### Example 3

The magnetic tape sample in Example 3 was obtained by the same method as in Example 1, except that the surface of the magnetic layer was ground with a grinding tape (cut-lapping) when the web of the magnetic recording medium was cut into a half width, and the surface was further subjected to blade grinding. The cut-lapping condition was as follows (the condition was the same in the following examples and comparative examples).

<Grinding Condition by Cut-lapping>

A abrasive tape (material: aluminum oxide, 800 mesh, trade name: WA#8000 manufactured by Fujimi Inc.) running in one direction at a feed speed of 100 mm/min was pressed onto the surface of the magnetic recording medium at a depression (the amount of protrusion) of 25 mm for grinding the magnetic recording medium while the magnetic recording medium was wound on a reel hub after cutting.

### Example 4

A sample of the magnetic tape in Example 4 was obtained by the same method as in Example 4, except that the surface of the magnetic recording medium was ground with the grinding tape under the same condition as in Example 3 when the web of the magnetic recording medium was cut into a half width after curing, and the magnetic recording medium was not ground with a blade thereafter.

### Example 5 to 8

Samples of the magnetic tapes in Examples 5 to 8 were obtained by the same method as in Example 1, except that the amount of abrasive added to the composition of the magnetic layer was changed as shown in Table 1 below, and the grinding condition of the web of the magnetic recording medium after curing was changed as shown in Table 1.

### Comparative Example 1

A sample of the magnetic tape in Comparative Example 1 was obtained as in Example 1, except that the amount of abrasive added to the composition of the magnetic layer was changed as shown in Table 1 below, and the web of the magnetic recording medium after curing was not ground.

### Example 9

A sample of the magnetic tape in Example 9 was obtained as in Example 1, except that the paint for forming the magnetic layer prepared by changing the amount of abrasive added as shown in Table 1 was applied on the nonmagnetic tape after applying the magnetic layer and before drying the magnetic layer, and the grinding condition of the web of the magnetic recording medium after curing was changed as shown in Table 1.

### Example 10

A sample of the magnetic tape in Example 10 was obtained as in Example 3, except that the dispersion circumference speed in the pin-mill preparing the paint for the magnetic layer was changed as shown in Table 1.

### Example 11

A sample of the magnetic tape in Example 11 was obtained as in Example 10, except that the diameter of the dispersion medium (zirconia beads) in the pin-mill in preparing the paint for the magnetic layer was changed as shown in Table 1.

### Comparative Example 2

A sample of the magnetic tape in Comparative Example 2 was obtained as in Example 10, except that the diameter of the dispersion medium (zirconia beads) in the pin-mill in preparing the paint for the magnetic layer, and the dispersion circumference speed were changed as shown in Table 1.

<Measurement of Average Protrusion Height of Abrasive with AFM>

The average protrusion height of the abrasive was measured using AFM and SEM with respect to the samples in the examples and comparative examples. AMF used was Auto Probe M5 manufactured by Thermo Microscopes Co., and the measurement was performed under the following scanning condition. SEM used was JEOL JSM-6340F manufactured by JEOL Datum Co.

Number of analyses: N=3

Probe: silicon single crystal probe (radius of curvature:

2nm, manufactured by Nano-Sensors Co.)

Scanning mode: non-contact mode

Scanning area: 3×3 μm (corresponds to plane area q)

Number of pixel: 128×128 data point

Scanning rate: 0.6 Hz

Measuring environment: room temperature, in air

Slope of image data, correction of curvature: correction in longitudinal and transverse directions for the data of total image (2D correction); procedure (input command): process/leveling/auto leveling/2D

In the actual procedure, an arbitrary area on the magnetic layer of each sample of the magnetic recording medium was scanned once using AFM and SEM, and the location of the abrasive was identified by comparing an AFM image with a SEM image. A cross-sectional shape of the surface of the magnetic layer was obtained thereafter using AFM, and the height of protrusion from a reference surface of the magnetic layer on the cross-section was determined with respect to three abrasives. The reference surface of the magnetic layer was determined at a horizontal plane corresponding to the height exhibiting the inflection point from the height-magnetic layer occupation ratio curve obtained by the AFM measurement.

The procedure above was repeated at two other areas of each sample of the magnetic recording medium, and the heights of protrusions of three abrasives for each three areas, or of nine abrasives, were measured. The average height of protrusion was determined by averaging the measured data above. The measured data above were processed using a data processing application SPMLab NT Ver. 50b11 produced by Thermo Microscopes Co.

<Measurement of Wear>

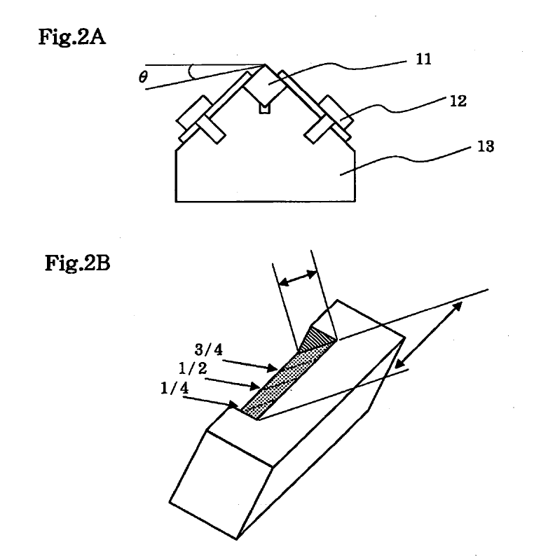

The amount of wear of sendust by the sample of each magnetic tape was measured using an apparatus shown in FIG. 2A. A sendust bar (a Fe—Si—Al alloy, trade name Block SD-5 manufactured by Tokin Co.) with a length of 25 mm and a cross-sectional area of 6.0 mm² was fixed on the main unit 13 of the apparatus shown in FIG. 2A with a fixing tool 12 so that the edge was in the vertical direction. The sendust bar 11 used for the measurement showed no wear and no chips with a length of 1 μm at the edge.

The tape was run by pressing each sample tape onto the edge of the sendust bar 11 with a one side tape rap angle θ of 12° and a tape tension of 1.0 N. The amount of wear was evaluated by wear patterns (width) of the sendust bar 11 after running as shown in FIG. 2B. The tape length of each tape was 580 m, and the tape running speed was 3.0 m/s with a running path of 100 (50 cycles). The wear pattern was measured at three point of ¼, ½ and ¾ of the width of sendust shown in FIG. 2B, and the amount of wear by each sample was obtained from an average of the data above.

<Evaluation of Durability>

Durability was evaluated at a temperature of 45° C. and a humidity of 20% using a linear tape drive provided with a combination type thin film magnetic head having an inductive head and a MR head. With respect to the drive, the track width of the MR head is 6 μm, the tape speed is 8 m/s and the tape tension is 0.48-1.2 N/10 mm. In the evaluation procedure, the tape was allowed to reciprocate 99 times for a 30 megabits (MB) portion at a 20 MB feed position from the top of the tape after 100 MB of recording, and 100 MB portion of the tape was reproduced once after the tape was rewound. This process was repeated 250 cycles to measure C1 error rates in the cycle. Measurement: 100 MB writing & rewinding→(20 MB feed→(30 MB×99 times of reciprocation)→100 MB reading & rewinding)×250 cycles

The assessment criteria were as follows:

A: 250 cycles of running without changes of error rate

B: 250 cycles of running with a slight increase of error rate

C: stopped before 250 cycles of running due to an increase of error rate

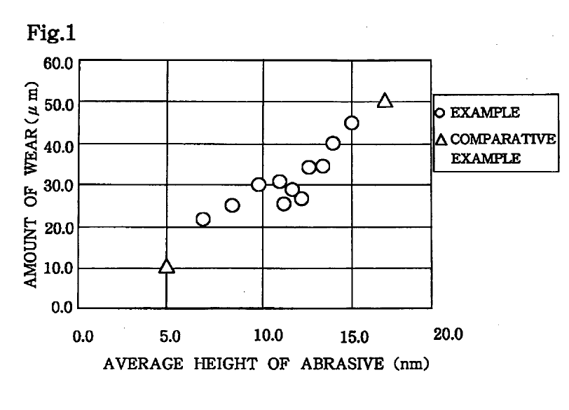

These results are shown in the following Table 1 and FIG. 1.

TABLE 1

| | ABRASIVE OF | | | | | GRIND | | AVERAGE | | |
|---|---|---|---|---|---|---|---|---|---|---|
| | MAGNETIC | | DISPERSION CONDITION | | | CONDITION | | HEIGHT OF | | |
| | LAYER (PART | | MEDIUM | CIRCUMFEREN- | COAT- | CUT- | | PROTRUSION OF | AMOUNT | |
| | BY WEIGHT) | | DIAMETER | TIAL | ING | LAPP- | | ABRASIVE | OF WEAR | DURA- |
| | HIT82 | HIT60A | (mm) | SPEED (m/s) | METHOD | ING | BLADE | (nm) | (μn) | BILITY |
| EXAMPLE 1 | 7 | 3 | 0.8 | 5.4 | W/D | NO | YES | 14.1 | 39.9 | A |
| EXAMPLE 2 | 7 | 3 | 0.8 | 5.4 | W/D | NO | YES | 15.0 | 44.6 | B |
| EXAMPLE 3 | 7 | 3 | 0.8 | 5.4 | W/D | YES | YES | 11.4 | 25.7 | A |
| EXAMPLE 4 | 7 | 3 | 0.8 | 5.4 | W/D | YES | NO | 12.3 | 26.8 | A |
| EXAMPLE 5 | 3 | 7 | 0.8 | 5.4 | W/D | YES | YES | 8.5 | 25.0 | A |
| EXAMPLE 6 | 3 | 7 | 0.8 | 5.4 | W/D | YES | NO | 11.1 | 30.7 | A |
| EXAMPLE 7 | 0 | 10 | 0.8 | 5.4 | W/D | YES | YES | 11.9 | 28.7 | A |
| EXAMPLE 8 | 0 | 10 | 0.8 | 5.4 | W/D | YES | NO | 12.4 | 33.7 | A |
| COMPARATIVE | 0 | 10 | 0.8 | 5.4 | W/D | NO | NO | 16.9 | 50.0 | C |
| EXAMPLE 1 | | | | | | | | | | |
| EXAMPLE 9 | 0 | 15 | 0.8 | 5.4 | W/W | YES | YES | 13.4 | 35.0 | A |
| EXAMPLE 10 | 7 | 3 | 0.8 | 7 | W/D | YES | YES | 9.9 | 29.8 | A |
| EXAMPLE 11 | 7 | 3 | 0.3 | 7 | W/D | YES | YES | 7.0 | 22.1 | B |
| COMPARATIVE | 7 | 3 | 0.1 | 10 | W/D | YES | YES | 5.0 | 10.4 | C |
| EXAMPLE 2 | | | | | | | | | | |

What is claimed is:

1. A magnetic recording medium at least having a nonmagnetic layer and magnetic layer sequentially laminated on one surface of a nonmagnetic substrate,
wherein the magnetic layer contains a magnetic powder, a binder resin and an abrasive,
wherein an average height of protrusion of the abrasive from the surface of the magnetic layer measured using an AFM is in the range of 7.0 to 15.0 nm.

2. The magnetic recording medium according to claim 1 used in a magnetic recording system comprising an MR head as a reproduction head.

3. The magnetic recording medium according to claim 1, wherein the magnetic layer is formed by applying on the nonmagnetic layer by a wet-on-dry method.

4. The magnetic recording medium according to claim 2, wherein the magnetic layer is formed by applying on the nonmagnetic layer by a wet-on-dry method.

5. The magnetic recording medium according to claim 1, wherein the magnetic layer has an average surface roughness Ra of not greater than 5 nm measured with an AFM.

6. The magnetic recording medium according to claim 2, wherein the magnetic layer has an average surface roughness Ra of not greater than 5 nm measured with an AFM.

7. The magnetic recording medium according to claim 3, wherein tho magnetic layer has an average surface roughness Ra of not greater than 5 nm measured with an AFM.

8. The magnetic recording medium according to claim 4, wherein the magnetic layer has an average surface roughness Ra of not greater than 5 nm measured with an AFM.

9. The magnetic recording medium according to claim 2, wherein the track width of the MR head is 1-12 μm.

10. The magnetic recording medium according to claim 2, wherein the tape speed of the magnetic recording system is 2-20 m/min.

11. The magnetic recording medium according to claim 2, wherein the tape tension of the magnetic recording system is 0.4-2.0 N/10 mm.
